(19) United States
(12) Patent Application Publication
(10) Pub. No.: US 2026/0016150 A1
(43) Pub. Date: Jan. 15, 2026

(54) LAMP HAVING PLUG-IN ELECTRICAL CONNECTION STRUCTURE

(71) Applicant: ZHI LI, Ningbo (CN)

(72) Inventor: ZHI LI, Ningbo (CN)

(21) Appl. No.: 19/281,873

(22) Filed: Jul. 28, 2025

(30) Foreign Application Priority Data
Jul. 11, 2024 (CN) 202410924467.9

(51) Int. Cl. F21V 23/06

(52) U.S. Cl. CPC F21V 23/06

(57) ABSTRACT

Disclosed in the present disclosure is a lamp having a plug-in electrical connection structure, including a lamp body and an electrical connector, where an assembly surface of the lamp body is provided with a protruding part, and a plug slot adapted to the protruding part is formed on the electrical connector; the electrical connector further includes a conducting strip, a first end of which protrudes from a first surface of the electrical connector, and a second of which extends to an inner side wall of the plug slot. The modularly designed electrical connector is in plug assembly with the lamp body through the plug slot, so that automatic production is realized, thereby effectively improving the production rate.

### CROSS-REFERENCE TO RELATED APPLICATIONS

This application claims priority to Chinese Patent Application No. 202410924467.9, filed on Jul. 11, 2024, which is hereby incorporated by reference in its entirety.

### TECHNICAL FIELD

The present disclosure relates to the field of lamp assembly, and in particular to, a lamp having a plug-in electrical connection structure.

### BACKGROUND

Lamps are devices for providing lighting, which may be used in different environments such as families, offices, and public places. In an existing solution, the lamps are usually connected to a power supply through a power supply box. In this solution, complicated circuits are not carried in the lamps, so that the lamps are lightweight, small in size, and more attractive in terms of decoration. However, in actual use, the connecting port and the lamp body are integrally arranged, so that the lamp is assembled in a more complicated manner. It is needed to weld the connecting port manually, so that the process is quite tedious, and the preparation time of a single lamp is long. It can be seen that there is an urgent need for a solution with a more reasonable structure to resolve the abovementioned technical problem.

### SUMMARY

Aiming at the technical problem that in the lamp in the prior art, the structure of the connecting port and the lamp body needs to be welded manually, and the preparation time is long, the present disclosure provides a solution.

In order to achieve the above objective, the present disclosure provides a lamp having a plug-in electrical connection structure, including:
a lamp body, where a light-emitting assembly is disposed in the lamp body, and a light-emitting surface and an assembly surface are formed at two opposite ends; and a protruding part is disposed on an outer wall of the lamp body, and an electrical contact strip electrically connected to the light-emitting assembly is disposed on one side of the protruding part; and
an electrical connector, where one end of the electrical connector is connected to a side plate, and a plug slot adapted to the protruding part is formed on the electrical connector; and the electrical connector further includes a plurality of groups of conducting strips, a first end of any conducting strip protrudes from a first surface of the electrical connector, and a second thereof extends to an inner side wall of the plug slot.

The electrical connector includes a main shell and a cover plate, and the main shell and the cover plate enclose a cavity for accommodating the plurality of groups of conducting strips; and one end of the cover plate is connected to the side plate, a part of an end surface of the main shell fits the side plate to limit the plurality of groups of conducting strips, and the other part of the end surface of the main shell define the plug slot together with the side plate.

A profile column is further disposed on a surface of the cover plate proximal to the main shell, one end of the profile column protrudes from the first surface, conducting pins are further disposed in a penetrating manner at both ends of the profile column, and the conducting pins are electrically connected to the first end of each of the conducting strips.

First limiting grooves are formed in the surface of the cover plate proximal to the main shell, and the quantity of the first limiting grooves is adapted to the quantity of the conducting strips; and the conducting strips are placed in the first limiting grooves.

Second limiting grooves are further formed in a part of the profile column located on the cover plate, the quantity of the second limiting grooves is adapted to the quantity of the first limiting grooves, the second limiting grooves communicate with the first limiting grooves, and the first end of each of the conducting strips extends along each of the second limiting grooves to be connected to the conducting pins.

Third limiting grooves are formed in the surface of the cover plate proximal to the main shell, the quantity of the third limiting grooves is adapted to the quantity of the second limiting grooves, the third limiting grooves communicate with the first limiting grooves, and the first end of each of the conducting strips extends to each of the third limiting grooves to form an elastic sheet part.

A plurality of groups of first protrusions that correspondingly press the conducting strips into the first limiting grooves are further disposed on a surface of the main shell proximal to the cover plate.

A plurality of groups of third protrusions that correspondingly press the conducting strips into the third limiting grooves are further disposed on a part of the end surface of the main shell.

The main shell and the cover plate are assembled by way of a snap fit or an interference fit.

The protruding part is a convex ring, the light-emitting assembly is a flexible light strip and is placed in the convex ring, and the electrical contact strip electrically connected to the flexible light strip is formed on an outer side surface of the convex ring.

The present disclosure has the following beneficial effects: compared with the prior art, the lamp having a plug-in electrical connection structure provided by the present disclosure includes a lamp body and an electrical connector, where a light-emitting assembly is internally disposed in the lamp body, and a light-emitting surface and an assembly surface are formed at two opposite ends; the assembly surface is provided with a protruding part, and an electrical contact strip electrically connected to the light-emitting assembly is disposed on one side of the protruding part; one end of the electrical connector is connected to a side plate, and a plug slot adapted to the protruding part is formed on the electrical connector; the electrical connector further includes a plurality of groups of conducting strips, a first end of any conducting strip protrudes from a first surface of the electrical connector, and a second thereof extends to an inner side wall of the plug slot. By designing a part responsible for connection with an external power supply box as the modular electrical connector, the electrical connector is in plug assembly with the lamp body through the plug slot. The lamp body and the electrical connector may be assembled by an automatic processing device, so that automatic production is realized without manual welding, thereby effectively improving the production rate.

### BRIEF DESCRIPTION OF DRAWINGS

FIG. 1 is a three-dimensional diagram of the present disclosure;

FIG. 2 is a schematic structural diagram of an electrical connector of the present disclosure;

FIG. 3 is an exploded view of the electrical connector of the present disclosure;

FIG. 4 is a schematic structural diagram of a cover plate of the present disclosure;

FIG. 5 is another schematic structural diagram of the cover plate of the present disclosure; and

FIG. 6 is a schematic structural diagram of a main shell of the present disclosure.

### DESCRIPTION OF NUMERALS OF MAIN COMPONENTS

1, lamp body; 11, protruding part; 2, electrical connector; 21, side plate; 22, plug slot;
23, main shell; 231, first protrusion; 232, second protrusion; 24, cover plate; 25, profile column;
26, first limiting groove; 27, second limiting groove; 271, first partitioned slot body; 272, second partitioned slot body;
28, third limiting groove; 3, conducting strip; 31, connecting part; 4, conducting pin.

### DESCRIPTION OF EMBODIMENTS

In order to express the present disclosure more clearly, the present disclosure will be further described in detail below in conjunction with drawings.

In the description below, example details are given to provide a deeper understanding of the present disclosure. Apparently, the described embodiments are merely a part of the embodiments of the present disclosure and are not all the embodiments. It should be understood that the specific embodiments are merely used to explain the present disclosure, rather than limiting the present disclosure.

It should be understood that when the terms “comprise” and/or “include” are used in the specification, they indicate the presence of the features, entireties, steps, operations, components or assemblies, rather than excluding the presence or addition of one or more other features, entireties, steps, operations, components, assemblies or their combinations.

Lamps are devices for providing lighting, which may be used in different environments such as families, offices, and public places. In an existing solution, the lamps are usually connected to a power supply through a power supply box. In this solution, complicated circuits are not carried in the lamps, so that the lamps are lightweight, small in size, and more attractive in terms of decoration. However, in actual use, the connecting port and the lamp body are integrally arranged, so that the lamp is assembled in a more complicated manner. It is needed to weld the connecting port manually, so that the process is quite tedious, and the preparation time of a single lamp is long. It can be seen that there is an urgent need for a solution with a more reasonable structure to resolve the abovementioned technical problem.

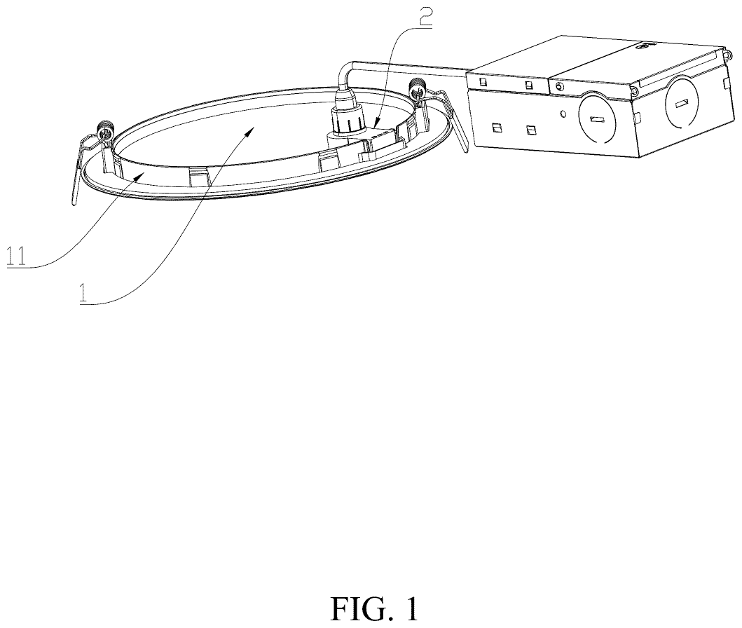

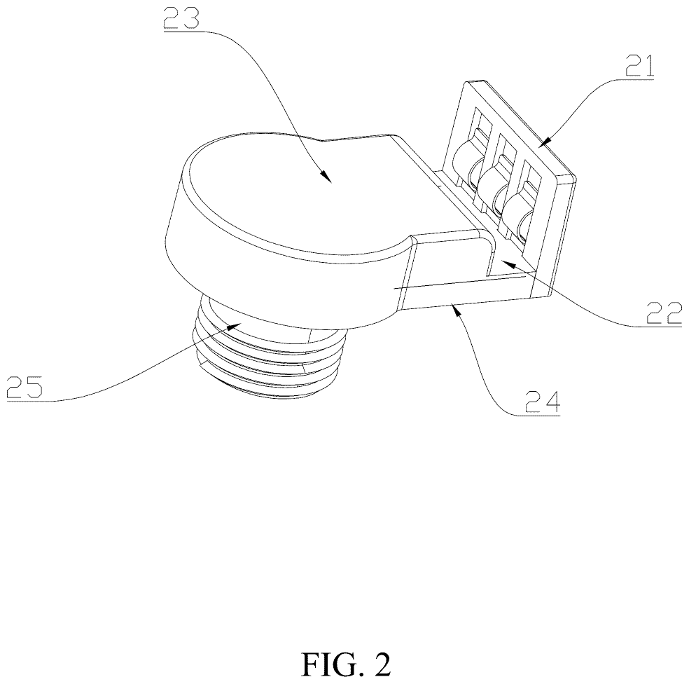

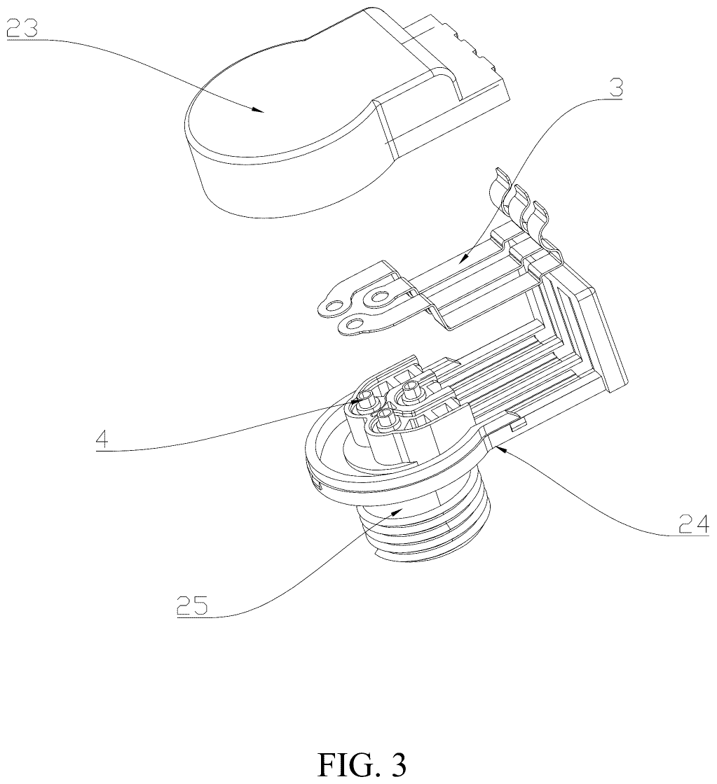

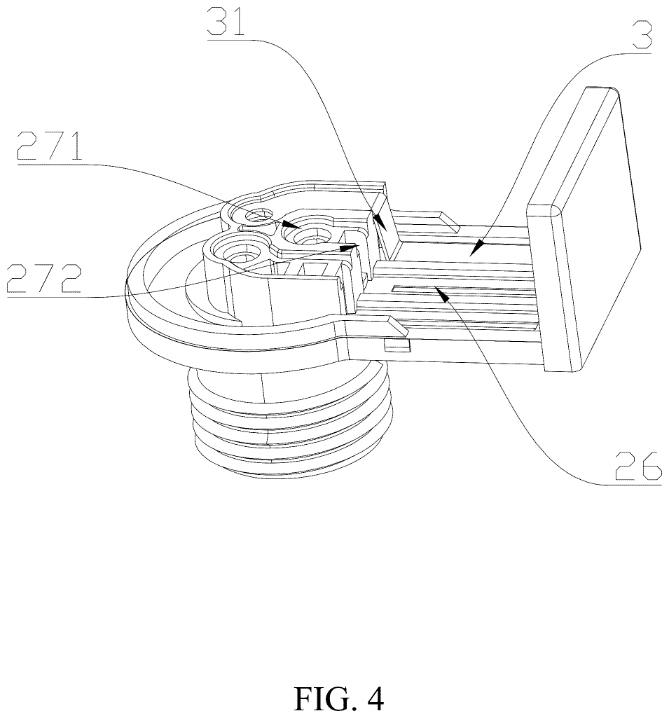

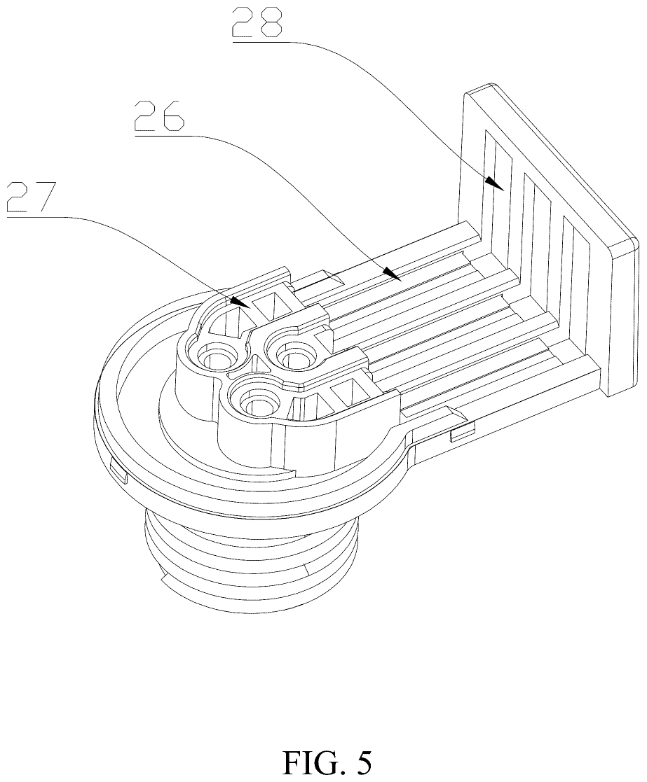

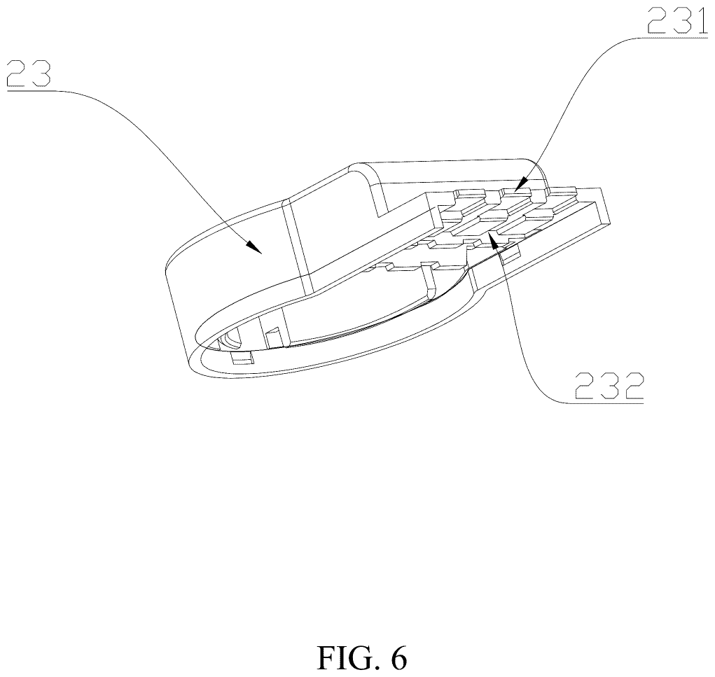

In order to resolve the abovementioned problem, the present application provides a lamp having a plug-in electrical connection structure. The lamp mentioned in the present application may be a downlight, a panel lamp, or another light-emitting lamp having an assembly requirement with the power supply box. Referring to FIGS. 1-6, the lamp includes a lamp body 1 and an electrical connector 2, where a light-emitting assembly is internally disposed in the lamp body 1, and a light-emitting surface and an assembly surface are formed at two opposite ends; the assembly surface is provided with a protruding part 11, and an electrical contact strip electrically connected to the light-emitting assembly is disposed on one side of the protruding part 11; one end of the electrical connector 2 is connected to a side plate 21, and a plug slot 22 adapted to the protruding part 11 is formed on the electrical connector; the electrical connector 2 further includes a plurality of groups of conducting strips 3, a first end of any conducting strip 3 protrudes from a first surface of the electrical connector 2, and a second thereof extends to an inner side wall of the plug slot 22. By designing a part responsible for connection with an external power supply box as the modular electrical connector 2, the electrical connector 2 is in plug assembly with the lamp body through the plug slot 22. The lamp body and the electrical connector may be assembled by an automatic processing device, so that automatic production is realized without manual welding, thereby effectively improving the production rate;

a specific production flow may be as follows: the lamp body and the electrical connector are prepared respectively; the lamp body is moved to a mounting position through a transport bed; a manipulator is mounted to clamp the electrical connector and insert the electrical connector to the lamp body to assemble the lamp body and the electrical connector, so as to obtain an intact lamp; and the lamp is transported to an expected position through the transport bed herein for collection, detection, and packaging.

In this embodiment, the electrical connector 2 includes a main shell 23 and a cover plate 24. The main shell 23 and the cover plate 24 enclose a cavity for accommodating the plurality of groups of conducting strips 3; one end of the cover plate 24 is connected to the side plate 21, and a part of an end surface of the main shell 23 fits the side plate 21 to limit the plurality of groups of conducting strips 3, and the other part of the end surface of the main shell defines the plug slot 22 together with the side plate 21; by form the cavity by the main shell 23 and the cover plate 24 to enclose the cover plate 24, the conducting strips 3 may be effectively protected, and one end of the main shell 23 and the cover plate 24 form the plug slot 22 through which the electrical connector 2 can be quickly plugged onto the lamp body 1; due to the integrated design of the cover plate 24 and the side plate 21, the conducting strips 3 can be led out conveniently; the main shell 23 does not cause interference; and during assembling, the side plate 21, the cover plate 24, and the end of the main shell 23 jointly extrude three surfaces of the protruding part 11, which can bring better mounting stability.

In a preferred solution, a profile column 25 is further disposed on a surface of the cover plate 24 proximal to the main shell 23, one end of the profile column 25 protrudes from a first surface, conducting pins 4 are further disposed in a penetrating manner at both ends of the profile column 25, and the conducting pins 4 are electrically connected to the first end of each of the conducting strips 3; the conducting pins 4 are fixed by the profile column 25, and the conducting pins 4 and the conducting strip 3 achieve an internal current conduction solution. The conducting pins 4 can provide better structural rigidity to better meet the subsequent mounting of the power supply box;

in order to further stably fix the conducting strips 3 in the cover plate 24, in this embodiment, first limiting grooves 26 are formed in the surface of the cover plate 24 proximal to the main shell 23, and the quantity of the first limiting grooves 26 is adapted to the quantity of the conducting strips 3; and the conducting strips 3 are placed in the first limiting grooves 26; it is not difficult to understand that the conducting strips 3 are limited by the first limiting grooves 26, and the conducting strips 3 move; in an actual solution, there are usually three conducting strips 3 corresponding to three conducting probes, i.e., electrical connections of corresponding wires of a neutral wire, a live wire or a ground wire of the external power supply box. Therefore, three first limiting grooves 26 are correspondingly formed to respectively accommodate three conducting strips 3, which can prevent a short circuit due to folding of the conducting strips 3 as a result of movement.

In a further solution, second limiting grooves 27 are further formed in a part of the profile column 25 located on the cover plate 24, the quantity of the second limiting grooves 27 is adapted to the quantity of the first limiting grooves 26, the second limiting grooves 27 communicate with the first limiting grooves 26 correspondingly, and the first end of each of the conducting strips 3 extends along each of the second limiting grooves 27 to be connected to the conducting pins 4; it is not difficult to understand that a mounting hole is formed in one end of each of the conducting strips 3, and each of the conducting strips is sleeved at the end of each of the conducting pins 4, i.e., an electrical connection between the conducting strips 3 and the conducting pins 4 is achieved; and the second limiting grooves 27 can effectively improve the mating stability of the conducting strips 3 and the conducting pins 4 on the profile column 25 to prevent the conducting strips 3 from escaping, thereby further improving the conducting stability.

In a further solution, third limiting grooves 28 are formed in the surface of the cover plate 21 proximal to the main shell 23, the quantity of the third limiting grooves 28 is adapted to the quantity of the second limiting grooves 27, the third limiting grooves 28 communicate with the first limiting grooves 26, and the first end of each of the conducting strips 3 extends to each of the third limiting grooves 28 to form an elastic sheet part. The third limiting grooves 28 can limit a second end of each of the conducting strips 3 to prevent a situation that the elastic sheet part cannot match the electrical connection position of the electrical connection part since the elastic sheet part loosens; and the elastic sheet part is additionally disposed to better meet scenarios of plug-in power distribution, so that the conducting stability is further improved.

In a preferred solution, the profile column 25 further protrudes from the surface of the cover plate 24, the second limiting grooves 27 are arranged along a column surface and an end surface of the profile column 25, and are denoted as a first partitioned slot body 271 and a second partitioned slot body 272. The conducting strip 3 on the second partitioned slot body 272 fits the conducting pin 4 to achieve an electrical connection. The position of the conducting strip 3 located in the first partitioned slot body 271 is denoted as a connecting part 31, a gap is reserved between the connecting part 31 and the second partitioned slot body 272, and a plane formed by the connecting part 31 is inclined toward a plane formed by the second partitioned slot body 272. Based on the above design, production personnel may assemble the conducting strips 3 quickly. Specific assembly steps are, for example, as follows: a user sleeves one end of the conducting strip 3 at the tail end of the conducting pin, so that the conducting strip 3 passes through the second limiting grooves 27, the first limiting grooves 26, and the third limiting grooves 28 to be limited; and since the connecting part 31 is in inclined fit with the first portioned slot body 271, the assembly difficulty is reduced.

In a preferred solution, a plurality of groups of first protrusions 231 that correspondingly press the conducting strips 3 into the first limiting grooves 26 are further disposed on a surface of the main shell 23 proximal to the cover plate 24; and a plurality of groups of third protrusions that correspondingly press the conducting strips 3 into the third limiting grooves 28 are further disposed on a part of an end surface of the main shell 23; it is not difficult to understand that in the assembled state of the cover plate 24 and the main shell 23, the first protrusions 231 can press the conducting strips 3, so that the conducting strips 3 can be stably assembled in the first limiting grooves 26 and the second protrusions 232 can press the conducting strips 3 at different angles, so that the conducting strips 3 can be more stably assembled in the third limiting grooves 28.

In a specific solution, the main shell 23 and the cover plate 24 are assembled by way of a snap fit or an interference fit. When the snap fit solution is adopted, a snap-fit opening may be formed in the inner wall of the main shell 23, fasteners are formed on both sides of the cover plate 24, and the fasteners match the snap-fit opening to achieve the snap fit; and the snap-fit opening may also communicate to the profile of the main shell 23 to form a snap-fit hole, and the snap-fit hole and the fasteners can bring an effect of high snap-fit stability; and in terms of the interference fit, the cover plate 24 and the main shell 23 may be processed by ultrasonic waves.

In this embodiment, the protruding part 11 is a convex ring, the light-emitting assembly is a flexible light strip and is placed in the convex ring, and the electrical contact strip electrically connected to the flexible light strip is formed on an outer side surface of the convex ring. By designing the protruding part as the convex ring, the overall thickness of the lamp may be effectively decreased, so that the lamp is more attractive while later mounting is facilitated, and the lamp is ornamental in terms of decoration.

The present disclosure has the following advantages:

1. By designing the part responsible for connection with an external power supply box as the modular electrical connector, the electrical connector is in plug assembly with the lamp body through the plug slot. The lamp body and the electrical connector may be assembled by an automatic processing device, so that automatic production is realized without manual welding, thereby effectively improving the production rate.

2. The conducting strips are limited by the plurality of groups of limiting grooves, which can bring more stable conducting performance.

3. The conducting pins are fixed by the profile column, and the conducting pins and the conducting strip achieve an internal current conduction solution. The conducting pins can provide better structural rigidity to better meet the subsequent mounting of the power supply box.

The above disclosure is merely a plurality of specific embodiments of the present disclosure, but the present disclosure is not limited thereto. Any variations thinkable by those skilled in the art shall fall within the protection scope of the present disclosure.

What is claimed is:

1. A lamp having a plug-in electrical connection structure, comprising:
a lamp body, wherein a light-emitting assembly is disposed in the lamp body, a protruding part is disposed on an outer wall of the lamp body, and an electrical contact strip electrically connected to the light-emitting assembly is disposed on one side of the protruding part; and
an electrical connector, wherein one end of the electrical connector is connected to a side plate, and a plug slot adapted to the protruding part is formed on the electrical connector; and the electrical connector further comprises a plurality of groups of conducting strips, a first end of any conducting strip protrudes from a first surface of the electrical connector, and a second thereof extends to an inner side wall of the plug slot.

2. The lamp having a plug-in electrical connection structure according to claim 1, wherein the electrical connector comprises a main shell and a cover plate, and the main shell and the cover plate enclose a cavity for accommodating the plurality of groups of conducting strips; and one end of the cover plate is connected to the side plate, a part of an end surface of the main shell fits the side plate to limit the plurality of groups of conducting strips, and the other part of the end surface of the main shell define the plug slot together with the side plate.

3. The lamp having a plug-in electrical connection structure according to claim 2, wherein a profile column is further disposed on a surface of the cover plate proximal to the main shell, one end of the profile column protrudes from the first surface, conducting pins are further disposed in a penetrating manner at both ends of the profile column, and the conducting pins are electrically connected to the first end of each of the conducting strips.

4. The lamp having a plug-in electrical connection structure according to claim 3, wherein first limiting grooves are formed in the surface of the cover plate proximal to the main shell, and the quantity of the first limiting grooves is adapted to the quantity of the conducting strips; and the conducting strips are placed in the first limiting grooves.

5. The lamp having a plug-in electrical connection structure according to claim 4, wherein second limiting grooves are further formed in a part of the profile column located on the cover plate, the quantity of the second limiting grooves is adapted to the quantity of the first limiting grooves, the second limiting grooves communicate with the first limiting grooves, and the first end of each of the conducting strips extends along each of the second limiting grooves to be connected to the conducting pins.

6. The lamp having a plug-in electrical connection structure according to claim 5, wherein third limiting grooves are formed in the surface of the cover plate proximal to the main shell, the quantity of the third limiting grooves is adapted to the quantity of the second limiting grooves, the third limiting grooves communicate with the first limiting grooves, and the first end of each of the conducting strips extends to each of the third limiting grooves to form an elastic sheet part.

7. The lamp having a plug-in electrical connection structure according to claim 6, wherein a plurality of groups of first protrusions that correspondingly press the conducting strips into the first limiting grooves are further disposed on a surface of the main shell proximal to the cover plate.

8. The lamp having a plug-in electrical connection structure according to claim 7, wherein a plurality of groups of third protrusions that correspondingly press the conducting strips into the third limiting grooves are further disposed on a part of the end surface of the main shell.

9. The lamp having a plug-in electrical connection structure according to claim 2, wherein the main shell and the cover plate are assembled by way of a snap fit or an interference fit.

10. The lamp having a plug-in electrical connection structure according to claim 1, wherein the protruding part is a convex ring, the light-emitting assembly is a flexible light strip and is placed in the convex ring, and the electrical contact strip electrically connected to the flexible light strip is formed on an outer side surface of the convex ring.
